(19) United States
(12) Patent Application Publication
(10) Pub. No.: US 2024/0037295 A1
(43) Pub. Date: Feb. 1, 2024

(54) AUTHORING SYSTEM AND METHOD FOR HIGH-PRECISION FIRE-DYNAMICS-SIMULATION

(71) Applicant: Electronics and Telecommunications Research Institute, Daejeon (KR)

(72) Inventors: Kyung Ho JANG, Daejeon (KR); Hae Dong KIM, Daejeon (KR); Hong Kee KIM, Daejeon (KR); Su Ran PARK, Daejeon (KR); Hyung Ki SON, Daejeon (KR); Ung Yeon YANG, Daejeon (KR)

(73) Assignee: Electronics and Telecommunications Research Institute, Daejeon (KR)

(21) Appl. No.: 18/110,437

(22) Filed: Feb. 16, 2023

(30) Foreign Application Priority Data
Jul. 29, 2022 (KR) 10-2022-0094580

(51) Int. Cl. G06F 30/20

(52) U.S. Cl. CPC G06F 30/20; G06F 2111/20

(57) ABSTRACT

A method, performed by an authoring system, of authoring content for a high-precision fire-dynamics-simulation (FDS) is provided. The authoring system selects a target object from an object DB storing a three-dimensional model of each object made to correspond to surface information indicating at least one material constituting a surface of the three-dimensional model and material information indicating fire attribute information of each material; arranges the selected target object in a three-dimensional space to author content for the FDS; converts the content for the FDS into an FDS input file used as an input for a simulator for the FDS; and outputs the FDS input file to the simulator.

### CROSS-REFERENCE TO RELATED APPLICATIONS

The present application is based on, and claims priority to, Korean Patent Application Number 10-2022-0094580, filed Jul. 29, 2022, the disclosure of which is incorporated by reference herein in its entirety.

### TECHNICAL FIELD

The present disclosure relates to an authoring system and method for a high-precision fire-dynamics-simulation, and more specifically, to an authoring system and method for a high-precision fire-dynamics-simulation capable of authoring content for utilization of a high-precision fire-dynamics-simulation that is used for fire situation analysis so that the content is applied to various fields such as fire suppression, fire analysis, and fire evacuation.

### BACKGROUND

The statements in the present section merely provide background information related to the present disclosure and do not necessarily constitute prior art.

When results of a fire-dynamics-simulation (FDS) are visualized and content is produced for use in fields such as fire analysis and fire evacuation, professional knowledge about fire is required. The reality is that FDS utilization is being used by some users or in some fields. Therefore, when content allowing users having slight knowledge about fire to easily utilize the FDS can be produced, the content can be applied to various fields of fire, such as fire reenactment, fire analysis, and a fire evacuation drill.

However, content for an FDS should be authored in order to apply the FDS to various fields of fire. A fire scene should be authored, and fire attribute of each material should be designated for various materials present in an authored environment. Here, the fire attribute means a basic component of the material, and important elements may be expressed as specific heat, conductivity, density, and the like. The fire attribute requires professional knowledge, and only users having professional knowledge who fully understand the fire attribute can set the fire attribute and obtain a result of the FDS. Accordingly, it is inevitably difficult for users having no professional knowledge to author content for utilization of the FDS, and only users having professional knowledge should author content for fire spaces, making it difficult for the content to be utilized in various fields such as a fire drill and fire analysis.

### SUMMARY

An object of the present disclosure is to provide an authoring system and method for a high-precision fire-dynamics-simulation capable of authoring content allowing users having slight knowledge about fire, including users having professional knowledge, to easily utilize the high-precision fire-dynamics-simulation.

According to an embodiment, a method, performed by an authoring system, of authoring content for a high-precision fire-dynamics-simulation (FDS) is provided. The authoring method includes: selecting a target object from an object DB storing a three-dimensional model of each object made to correspond to surface information indicating at least one material constituting a surface of the three-dimensional model and material information indicating fire attribute information of each material; arranging the selected target object in a three-dimensional space to author content for the FDS; converting the content for the FDS into an FDS input file used as an input for a simulator for the FDS; and outputting the FDS input file to the simulator.

The authoring method may further include: receiving surface information for a surface of a three-dimensional model of a new object and fire attribute information for the surface information from a user by referring to a fire attribute DB, which comprises a plurality of pieces of surface information including a plurality of materials and has the material information indicating the fire attribute information of each corresponding material set in the plurality of pieces of surface information; and storing in the object DB the surface information and the fire attribute information made to correspond to the three-dimensional model of the new object.

The authoring method may further include modifying the fire attribute information stored in the fire attribute DB or registering new fire attribute information.

When the fire attribute information stored in the fire attribute DB is changed, the changed fire attribute information may be reflected in the object DB.

The authoring may include arranging the selected target object in the three-dimensional space and modifying the fire attribute information of the at least one material constituting the surface of the three-dimensional model.

The fire attribute information may include at least one of specific heat, conductivity, density, heat of combustion, or heat of reaction of the material.

The authoring may include performing environment settings for the FDS in the three-dimensional space.

The authoring may include acquiring an FDS result from the simulator and visualizing the FDS result.

According to another embodiment, an authoring system for authoring content for a high-precision fire-dynamics-simulation (FDS) is provided. The authoring system includes: an object DB configured to store surface information indicating at least one material constituting a surface of a three-dimensional model of each object and material information indicating fire attribute information of the material together with the three-dimensional model made to correspond to each other; an authoring unit configured to select a target object from the object DB, and arrange the selected target object in a three-dimensional space to author content for an FDS; and an FDS input file generation unit configured to convert the content for the FDS into an FDS input file used as an input for a simulator for the FDS, and output the FDS input file to the simulator.

The authoring system may include a fire attribute DB including a plurality of pieces of surface information comprising a plurality of materials and having the material information indicating the fire attribute information of each corresponding material set in the plurality of pieces of surface information, wherein the authoring unit includes an object DB management unit configured to receive surface information for a surface of a three-dimensional model of a new object and fire attribute information for the surface information from a user by referring to the fire attribute DB, and store in the object DB the surface information and the fire attribute information made to correspond to the three-dimensional model of the new object.

The authoring unit may further include a fire attribute management unit configured to manage the fire attribute DB, and the management may include modification of the fire attribute information of the fire attribute DB and registration of new fire attribute information.

The authoring unit may further include an environment setting unit configured to set an environment of the three-dimensional space for performing the FDS.

The arrangement unit arranges the three-dimensional model of the selected target object in the three-dimensional space and modifies a fire attribute of the material constituting the surface of the three-dimensional model by referring to the fire attribute DB.

The fire attribute information may include at least one of specific heat, conductivity, density, heat of combustion, or heat of reaction of the material.

The authoring system may further include a visualization unit configured to acquire an FDS result from the simulator and visualize the FDS result.

According to the embodiment, users having no professional knowledge can author content for an FDS and apply or utilize various fire-dynamics-simulations, and, as a result, can conduct drills such as fire evacuation under an environment simulation similar to reality in schools or other institutions at minimal cost.

### BRIEF DESCRIPTION OF THE DRAWINGS

FIG. 1 is a diagram illustrating an authoring system for a high-precision fire-dynamics-simulation according to an embodiment.

FIG. 2 is a diagram illustrating an example of fire attribute information stored in an object DB illustrated in FIG. 1.

FIG. 3 is a diagram illustrating a relationship between a fire attribute DB and the object DB illustrated in FIG. 1.

FIG. 4A and FIG. 4B are diagrams illustrating a concept of the operations between the fire attribute DB and a three-dimensional model.

FIG. 5 is a diagram illustrating an authoring unit illustrated in FIG. 1.

FIG. 6 is a diagram illustrating an FDS input file generation unit illustrated in FIG. 1.

FIG. 7A to FIG. 7C are diagrams illustrating reconstruction of an object model according to a mesh size setting.

FIG. 8A is a flowchart illustrating an authoring method for an FDS according to an embodiment.

FIG. 8B and FIG. 8C are diagrams illustrating content for an FDS and a visualized FDS result.

FIG. 9 is a diagram illustrating an authoring system for an FDS according to another embodiment.

### DETAILED DESCRIPTION

Hereinafter, some embodiments of the present disclosure will be described in detail with reference to the accompanying drawings. As those skilled in the art would realize, the described embodiments may be modified in various different ways, all without departing from the spirit or scope of the description. In the following description, like reference numerals preferably designate like elements, although the elements are shown in different drawings. Further, in the following description of some embodiments, a detailed description of related known components and functions when considered obscuring the subject of the present disclosure will be omitted for the purpose of clarity and for brevity.

Various ordinal numbers or alpha codes such as first, second, i), ii), a), b), etc., are prefixed solely to differentiate one component from the other but not to imply or suggest the substances, order, or sequence of the components. Throughout the present specification, when a part “includes” or “comprises” a component, the part is meant to further include other components, to not exclude thereof unless specifically stated to the contrary. Hereinafter, an authoring system and a method for a high-precision fire-dynamics-simulation according to an embodiment of the present disclosure will be described in detail with reference to the drawings.

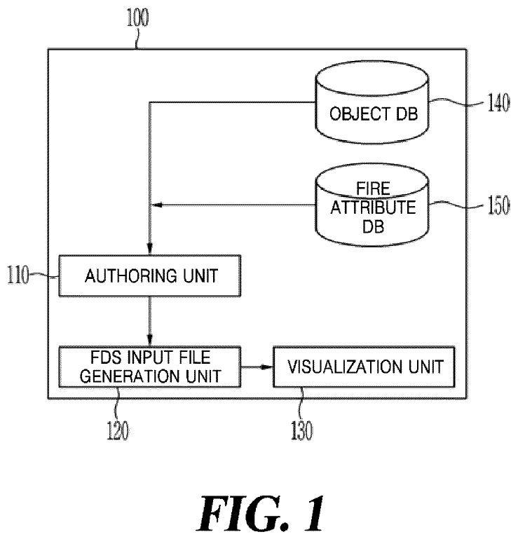

FIG. 1 is a diagram illustrating an authoring system for a high-precision fire-dynamics-simulation according to an embodiment.

Referring to FIG. 1, the authoring system 100 for a high-precision fire-dynamics-simulation includes an authoring unit 110, a high-precision fire-dynamics-simulation (FDS) input file generation unit 120, a visualization unit 130, an object database (DB) 140, and a fire attribute DB 150.

The authoring unit 110 directly authors content for an FDS. The content for an FDS may include, for example, an environment for an FDS. The authoring unit 110 selects a necessary object from the object DB 140, arranges the selected object in a three-dimensional space, resizes the object, and performs environment settings for an FDS to author the content for an FDS.

The FDS input file generation unit 120 converts the content authored by the authoring unit 110 into an FDS input file. The FDS input file is an input file for a simulator (hereinafter referred to as FDS simulator) that performs the FDS and calculates a result of the FDS.

The visualization unit 130 visualizes the result of the FDS.

The object DB 140 stores object information in which a fire attribute has been designated. The object may include not only a simple three-dimensional model, but also various devices (a sprinkler, a fire detector, or the like) required for calculation of a fire phenomenon in the FDS. The device is arranged in the three-dimensional space, like the three-dimensional model in the object DB 140. For example, the authoring unit 110 may bring a temperature measurement device from the object DB 140 and arrange the temperature measurement device in the three-dimensional space in order to obtain a temperature.

The fire attribute DB 150 includes information on a substance of a surface of the three-dimensional model of the object, that is, a material, a species of the surface, particles, and a fire attribute of the material, and the like. The fire attribute means a basic component of the material and can be expressed by a specific heat, conductivity, density, or the like.

The fire attribute is basic data for obtaining results from the FDS simulator, and a task of setting or modifying the fire attribute for the object requires professional knowledge or corresponding accurate data.

In the present disclosure, the fire attribute is made to correspond to the three-dimensional model of the object and stored in the object DB 140, and thus, a user only needs to select an object to be arranged in the three-dimensional space in the object DB 140, making it possible to easily author the content for an FDS without professional knowledge.

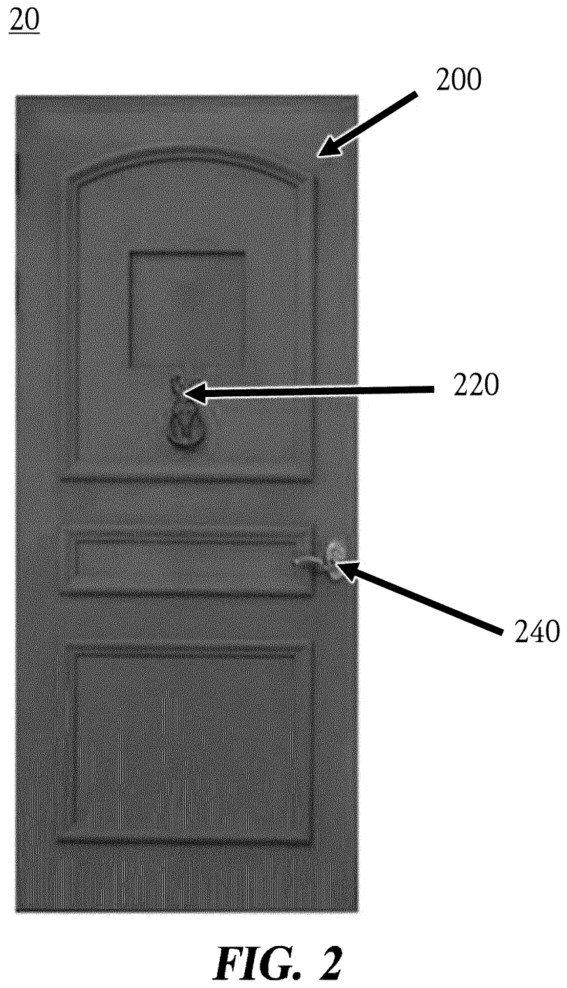

FIG. 2 is a diagram illustrating an example of fire attribute information stored in the object DB illustrated in FIG. 1.

The three-dimensional model of the object stored in the object DB 140 may be identified by an object identifier.

In the object DB 140, surface information indicating a material constituting the surface of the three-dimensional model of the object is made to correspond to the object identifier and stored. The surface information may include material information of a surface constituting the object, information on a species and particles of the surface, and the surface of the three-dimensional model of the object may be formed of one material or may be formed of various materials. The material information may include fire attribute information expressed by a specific heat, conductivity, density, and the like. The fire attribute information may include heat of combustion, number of set reactions (N_REACTIONS), heat of reaction, and the like.

For example, referring to FIG. 2, an object that is a door 20 may be comprised of, for example, a door body 200, a knob 240, and a ring 220, and it is assumed that the door body 200 is made of wood, the ring 220 of the door is made of aluminum, and the knob 240 of the door is made of PVC. In this case, since a surface of a three-dimensional model of the object that is the door 20 is formed of a material such as wood, aluminum, or PVC, material information corresponding to the wood that is a material constituting the door body 200, the aluminum that is a material constituting the ring 220, and the PVC that is a material constituting the knob 240 may be linked in correspondence to an object identifier of the door 20 in the object DB 140.

Tables 1 to 3 are tables showing material information corresponding to the wood, the aluminum, and the PVC, respectively.

TABLE 1

```
&MATL ID=‘WOOD’,
  FYI=‘NISTIR 1013-1 - NIST NRC Validation’,
  SPECIFIC_HEAT=1.3,
  CONDUCTIVITY=0.2,
  DENSITY=570.0,
  HEAT_OF_COMBUSTION= 14500.0,
  N_REACTIONS=1
  HEAT_OF_REACTION=430.0,
  MATL_ID(1,1)= ‘CHAR’,
  NU_MATL(1,1)=0.82,
  SPEC_ID(1,1)= ‘PYROLYZATE’,
  SPEC_ID(2,1)= ‘OXYGEN’,
  SPEC_ID(3,1)= ‘WATER VAPOR’,
  SPEC_ID(4,1)= ‘CARBON DIOXIDE’,
  NU_SPEC(1,1)=0.82,
  NU_SPEC(2,1)=0.0,
  NU_SPEC(3,1)=0.0,
  NU_SPEC(4,1)=0.0,
  A=18900000000.0,
  E=151000.0/
```

TABLE 2

```
&MATL ID=‘ALUMINUM’,
  FYI=‘NISTIR 1013-1 - NIST NRC Validation’,
  SPECIFIC_HEAT=0.9,
  CONDUCTIVITY=200.0,
  DENSITY=2700.0/
```

```
TABLE 3
&MATL ID=‘PVC’,
  FYI=‘PAPER : VERIFICATION AND VALIDATION OF
CANDIDATE SOOTDEPOSITION’,
  SPECIFIC_HEAT_RAMP=‘PVC_SPECIFIC_HEAT_RAMP’,
  CONDUCTIVITY_RAMP=‘PVC_CONDUCTIVITY_RAMP’,
  DENSITY=1380.0,
  EMISSIVITY=0.95/
&RAMP ID=‘PVC_SPECIFIC_HEAT_RAMP’, T=23.0, F=1.29/
&RAMP ID=‘PVC_SPECIFIC_HEAT_RAMP’, T=50.0, F=1.35/
&RAMP ID=‘PVC_SPECIFIC_HEAT_RAMP’, T=75.0, F=1.41/
&RAMP ID=‘PVC_SPECIFIC_HEAT_RAMP’, T=100.0, F=1.47/
&RAMP ID=‘PVC_SPECIFIC_HEAT_RAMP’, T=125.0, F=1.53/
&RAMP ID=‘PVC_SPECIFIC_HEAT_RAMP’, T=150.0, F=1.59/
&RAMP ID=‘PVC_CONDUCTIVITY_RAMP’, T=23.0, F=0.192/
&RAMP ID=‘PVC_CONDUCTIVITY_RAMP’, T=50.0, F=0.175/
&RAMP ID=‘PVC_CONDUCTIVITY_RAMP’, T=75.0, F=0.172/
&RAMP ID=‘PVC_CONDUCTIVITY_RAMP’, T=100.0, F=0.147/
&RAMP ID=‘PVC_CONDUCTIVITY_RAMP’, T=125.0, F=0.141/
&RAMP ID=‘PVC_CONDUCTIVITY_RAMP’, T=150.0, F=0.134/
```

The material information can be identified by a material identifier, and includes fire attribute information for the material.

The material identifier may have a correspondence relationship with a surface identifier of surface information constituting the three-dimensional model.

On the other hand, even in a case in which objects are the same door 20, when surface information linked to each object is designated as wood, the door becomes a wooden door, and when the surface information is linked to “iron”, the door becomes an iron door. The same models are expressed as objects with different fire attributes depending on the linked surface information.

In the case of a wall, when the wall is made of concrete, “concrete” is designated as the fire attribute, and when the wall is a plane made of plywood, a fire attribute corresponding to the plywood is designated for a wall model, so that a three-dimensional object for an FDS is generated.

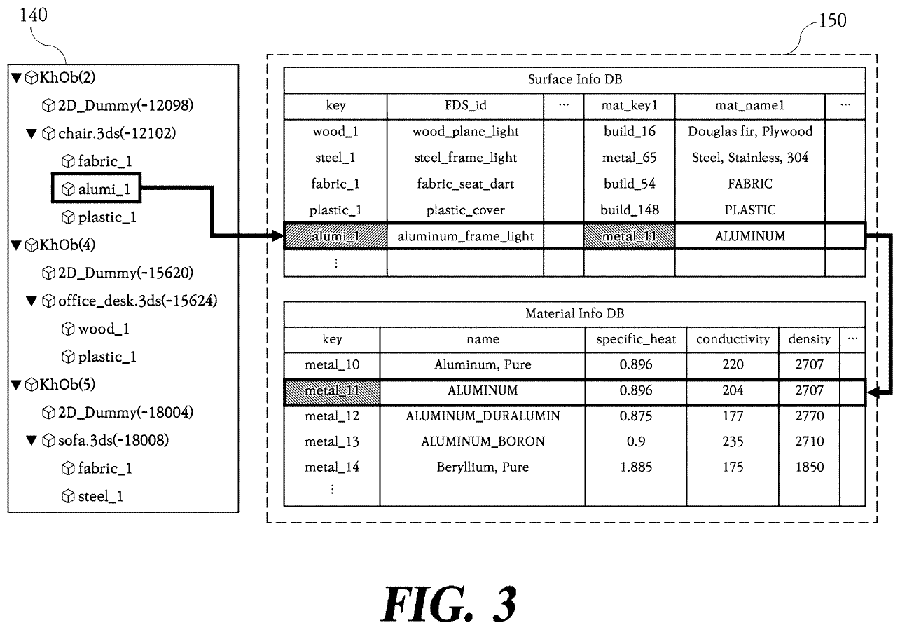

FIG. 3 is a diagram illustrating a relationship between the fire attribute DB and the object DB illustrated in FIG. 1.

Referring to FIG. 3, object information on, for example, a chair, a desk, and a sofa are stored in the object DB 140.

For example, the object information on the chair is linked to surface information corresponding to fabric 1, aluminum_1, and plastic_1, which are materials constituting the chair in a surface information DB in the fire attribute DB 150, and the surface information corresponding to fabric_1, aluminum_1, and plastic_1 is linked to the material information of a material information DB in the fire attribute DB 150.

That is, each of the objects stored in the object DB 140 may have a correspondence relationship with the material information of the surface, that is, the fire attribute information, through surface information of the three-dimensional model constituting the corresponding object.

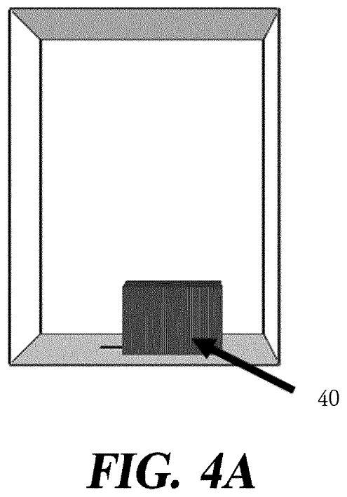

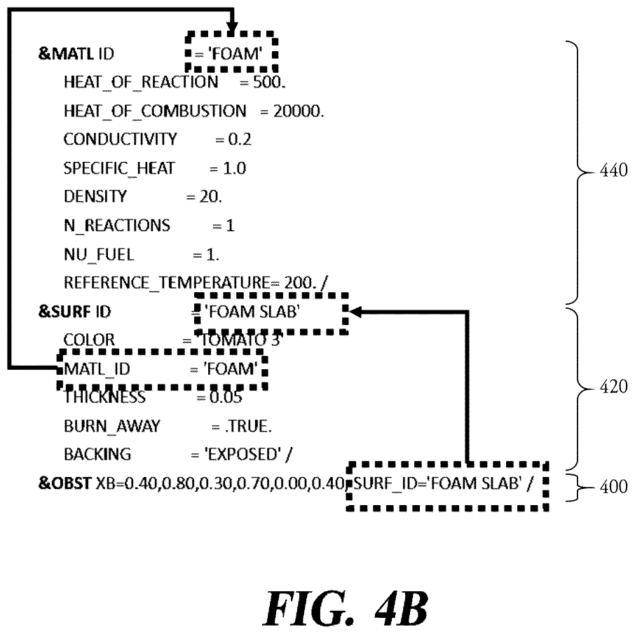

FIG. 4A and FIG. 4B are diagrams illustrating a concept of the operations between the fire attribute DB and the three-dimensional model.

Referring to FIG. 4A, an object 40 in the FDS is formed of a material called “FOAM”. In this case, as illustrated in FIG. 4B, information indicating that the object 40 is formed of “FOAM” is stored in the object DB 140 together with the three-dimensional model of the object. In this case, the information indicating that the object 40 is formed of “FOAM” is expressed as surface information called ‘FOAM SLAB’ and material information called ‘FOAM’ of the fire attribute DB 150. The material information called ‘FOAM’ includes fire attribute information of the material. In this case, the surface information called ‘FOAM SLAB’ may include color, material information, thickness, and the like, and ‘FOAM’ is set in the material information in the surface information called ‘FOAM SLAB’ so that the surface information called ‘FOAM SLAB’ and the material information called ‘FOAM’ in the material information DB have a link relationship.

The authoring unit 110 brings the three-dimensional model stored in the object DB 140 and arranges the three-dimensional model in the three-dimensional space, and arranged object information is transferred to the FDS input file generation unit 120.

For example, when the object 40 stored in the object DB 140 is selected as an object to be arranged in the three-dimensional space, information on the object 40 is transferred to the FDS input file generation unit 120.

When the FDS input file generation unit 120 receives the object information from the authoring unit 110, the FDS input file generation unit 120 converts the object information into a format represented in the FDS simulator. For example, when a three-dimensional object having the fire attribute assigned thereto is arranged, the three-dimensional object is converted into &OBST 400, &SURF 420, and &MATL 440 by the FDS input file generation unit 120 and transferred to the FDS simulator.

That is, when a user having no professional knowledge about fire finds the object 40 made of “FOAM” in the object DB 140 and arranges the object 40 in the three-dimensional space for content authoring, even the fire attribute information corresponding to the material information of the surface constituting the object 40 is transferred to the FDS simulator.

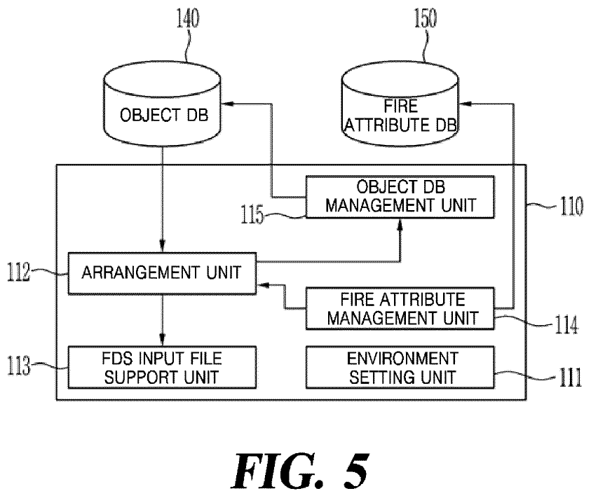

FIG. 5 is a diagram illustrating the authoring unit illustrated in FIG. 1.

Referring to FIG. 5, the authoring unit 110 includes an environment setting unit 111, an arrangement unit 112, an FDS input file support unit 113, a fire attribute management unit 114, and an object DB management unit 115.

The environment setting unit 111 sets an environment of the three-dimensional space for performing the FDS. The environment setting unit 111 sets environmental information, such as a mesh size, a zone in which a simulation is to be executed, and a climate element such as wind.

The arrangement unit 112 may select a device for obtaining the three-dimensional model and/or various types of information of an object from the object DB 140, arrange the device in the three-dimensional space, and modify a fire attribute of the arranged object when necessary. Further, the arrangement unit 112 performs functions required for overall content authoring, such as designating a fire ignition point.

The three-dimensional model whose fire attribute information has been modified in the arrangement unit 112, various newly created devices, and the like are stored in the object DB 140 through the object DB management unit 115. Further, when the user selects new three-dimensional data of an external source instead of the object DB 140, the object DB management unit 115 receives input of fire attribute information for the three-dimensional data from the user, sets the input fire attribute information in the three-dimensional data, and stores in the object DB 140 new three-dimensional data having fire attribute information set therein. The user can search a fire attribute DB 150 for the fire attribute information of the new three-dimensional data. When there is no corresponding fire attribute in the fire attribute DB 150, fire attribute information of the new three-dimensional data may be added to the fire attribute DB 150, and then, the fire attribute information may be set in the new three-dimensional data.

The FDS input file support unit 113 transfers the object information arranged in the arrangement unit 112 to the FDS input file generation unit 120. The FDS input file support unit 113 may transfer changed information to the FDS input file generation unit 120 each time there is a change in the arrangement unit 112.

The fire attribute management unit 114 manages the fire attribute DB 150. The fire attribute management unit 114 modifies the fire attribute information of the fire attribute DB 150 or generates new fire attribute information and registers the new fire attribute information in the fire attribute DB 150. When the fire attribute information of the fire attribute DB 150 is changed, the fire attribute management unit 114 applies the changed fire attribute information to the object DB 140 without needing to modify the fire attribute information in the object DB 140. Therefore, it is not necessary to modify the fire attribute information in the object DB 140 even when the fire attribute information of the fire attribute DB 150 is changed.

A method of arranging an object in the arrangement unit 112 is to move or resize the object, as in a normal authoring tool. When an object to be arranged is present in the object DB 140, it is possible to add an object required for an FDS to the content by bringing a desired object in the object DB 140 and arranging the object in the three-dimensional space, as in an authoring tool.

When an object is not present in the object DB 140, professional knowledge about fire may be required, but if the object DB 140 is well constructed, it is possible to provide an environment in which a user having slight knowledge about fire can author content.

Surface information for the three-dimensional object can be set by designating an element (for example, a surface made of iron when iron is used) in the surface information DB of the fire attribute DB 150 for each face of the three-dimensional model.

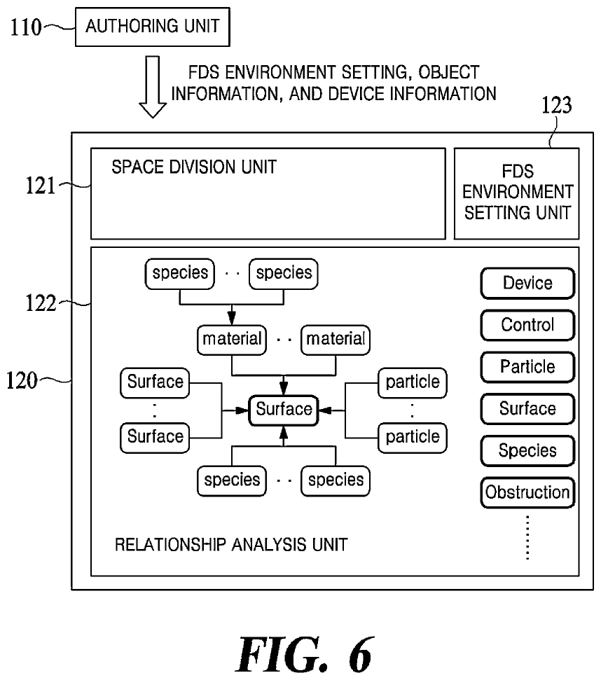

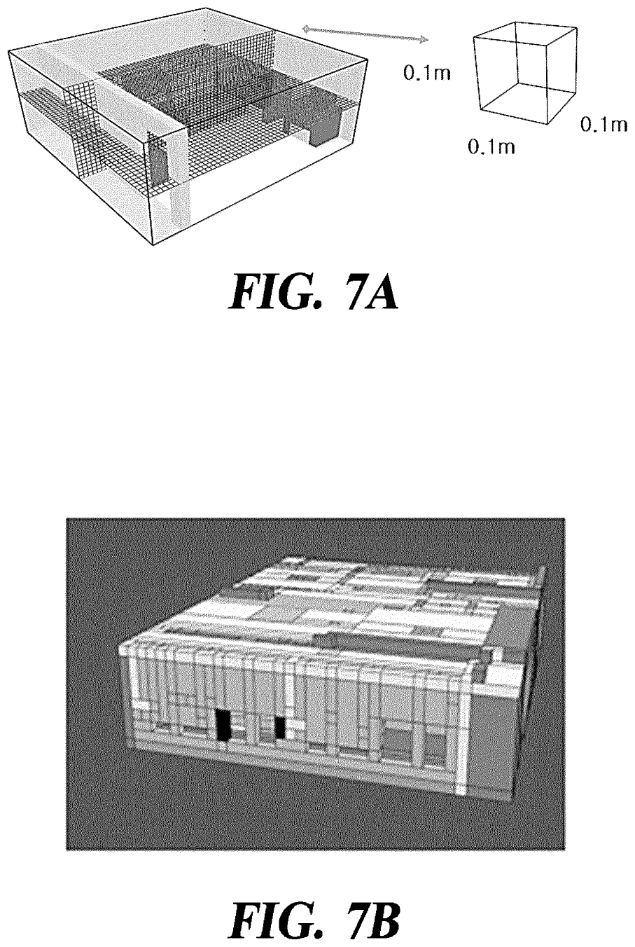

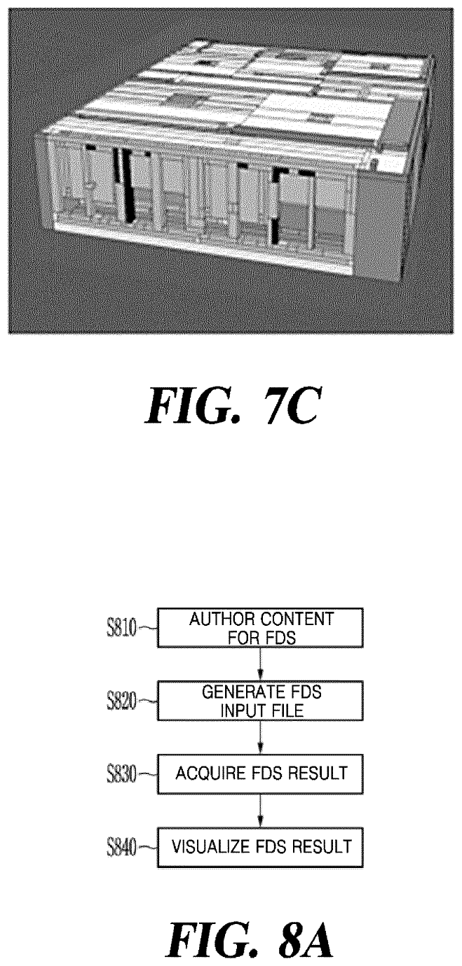

FIG. 6 is a diagram illustrating the FDS input file generation unit illustrated in FIG. 1. FIG. 7A to FIG. 7C are diagrams illustrating reconstruction of an object model according to a setting of the mesh size.

Referring to FIG. 6, when content authoring for an FDS is completed by the authoring unit 110, the authoring unit 110 transfers FDS environment setting information, object information, and device information to the FDS input file generation unit 120.

The FDS input file generation unit 120 converts the three-dimensional object arranged by the authoring unit 110, the device, and an FDS environment setting into the FDS input file using a parsing technology. The parsing technology is a technology for converting various types of information such as the FDS environment setting, the arranged three-dimensional object, the FDS environment setting information, and various devices into an input format of the FDS simulator, and then creates a final FDS input file.

Such a parsing technology may include space division, relationship analysis, and environment setting functions. That is, the FDS input file generation unit 120 may include a space division unit 121, a relationship analysis unit 122, and an FDS environment setting unit 123.

The space division unit 121 reconstructs the three-dimensional model according to the mesh size indicating how a space is to be divided in the FDS environment setting of the authoring unit 110. Referring to FIG. 2, the reconstruction refers to a task of dividing a size of the three-dimensional model according to a given mesh size. As illustrated in FIG. 7B and FIG. 7C, the space division unit 121 may reconstruct the three-dimensional model according to the mesh size. FIG. 7B shows a reconstructed three-dimensional model when the mesh size is set to 0.25 m, and FIG. 7C shows the reconstructed three-dimensional model when the mesh size is set to 0.125 m. The mesh size may be set to, for example, 0.1 m, 0.25 m, 0.125, and the like. A more accurate FDS result can be obtained when the mesh size is smaller.

The space division unit 121 expresses the reconstructed three-dimensional model as an obstruction (OBST). In this case, the three-dimensional model may be decomposed into small sizes according to a setting of the mesh size and expressed by many OBSTs.

Each OBST may be linked to one or more pieces of surface information (&SURF), each piece of surface information (&SURF) may be linked to one or more pieces of material information (&MATL), and the material information (&MATL) may be linked to a plurality of pieces of species information (&SPEC). Further, various types of device information (&DEVC) obtained from the FDS may be linked to other device information (&DEVC).

The relationship analysis unit 122 analyzes such a link relationship, generates object information having a fire attribute assigned thereto and various types of information as the FDS input file based on the link relationship, and outputs the FDS input file.

The FDS environment setting unit 123 records, in the FDS input file, information on a basic environment for performing the FDS.

Thus, the FDS input file generation unit 120 generates the content created by the user in the authoring unit 110 as the FDS input file. Table 4 shows an example of the FDS input file.

TABLE 4
&HEAD CHID=‘box_burn_away’, TITLE=‘Test BURN_AWAY
feature’ /
&MESH IJK=20,20,40 XB=0.0,1.0,0.0,1.0,0.0,2.0 /
&TIME TWFIN=120. /

| | |
|---|---|
| &MATL ID | = ‘FORM’ |
| HEAT_OF_REACTION | = 500. |
| HEAT_OF_COMBUSTION | = 20000. |
| CONDUCTIVITY | = 0.2 |
| SPECIFIC_HEAT | = 1.0 |
| DENSITY | = 20. |
| N_REACTIONS | = 1 |
| NU=FUEL | = 1. |
| REFERENCE_TEMPERATURE | = 200. / |
| &SURF ID | = ‘FORM SLAB’ |
| COLOR | = ‘TOMATO 3’ |
| MATL_ID | = ‘FORM’ |
| THICKNESS | = 0.05 |
| BURN_AWAY | = .TRUE. |
| BACKING | = ‘EXPOSED’ / |

&SURF ID = ‘FIRE’, HRRPUA=1000., COLOR=‘RED’ /

| | |
|---|---|
| &VENT | SUFR_ID=‘FIRE’ / |
| XB=0.30,0.40,0.45,0.55,0.00,0.00, | |
| &OBST | SUFR_ID=‘FOAM SLAB’ / |
| XB=0.40,0.80,0.30,0.70, 0.00,0.40, | |
| &VENT MB=‘XMIN’, | SURF_ID=‘OPEN’ / |
| &VENT MB=‘XMAX’, | SURF_ID=‘OPEN’ / |
| &VENT MB=‘YMIN’, | SURF_ID=‘OPEN’ / |
| &VENT MB=‘YMAX’, | SURF_ID=‘OPEN’ / |

&BNDF QUANTITY=‘Wall_TEMPERATURE’ /
&BNDF QUANTITY=‘BURNING RATE’ /
&BNDF QUANTITY=‘HEAT_FLUX’ /
&SLCF PBX=0.5, QUANTITY=‘TEMPERATURE’,
VECTOR=.TRUE. /
&SLCF PBX=0.5, QUANTITY=‘HRRPUV’ /
&TAIL /

The FDS input file is input into the FDS simulator.

The visualization unit 130 acquires the FDS result from the FDS simulator and visualizes the FDS result.

The user may confirm a visualization result using the content (fire space) authored by the user, and may confirm and analyze various results related to various fires depending on setting options in the content authored by the user.

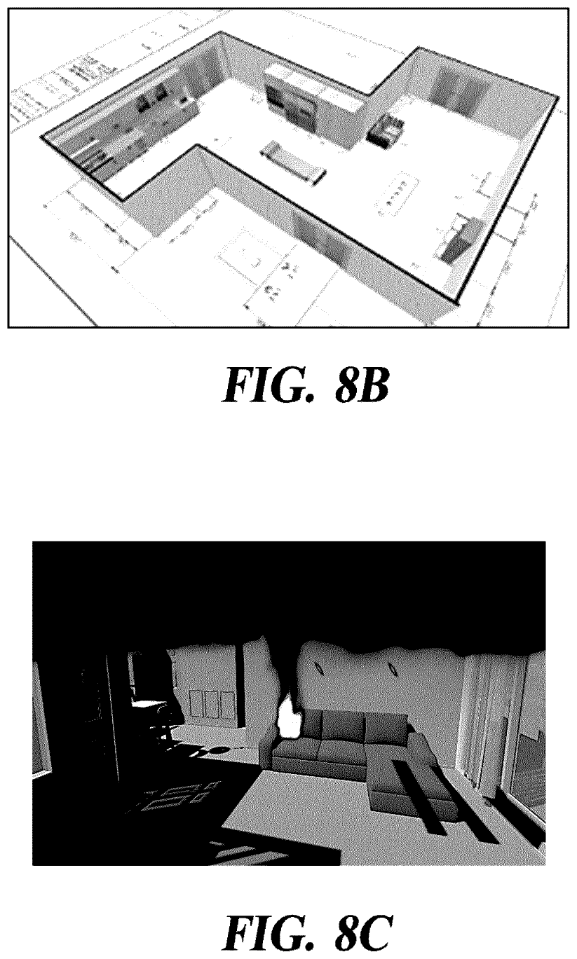

FIG. 8A is a flowchart illustrating an authoring method for an FDS according to an embodiment. FIG. 8B and FIG. 8C are diagrams illustrating content for an FDS and a visualized FDS result. The method illustrated in FIG. 8A may be implemented by one or more functions of the above-described authoring system being performed by at least one computing device. Accordingly, the following description may also be understood as an operation performed by the computing device.

Referring to FIG. 8A, the authoring system selects a necessary object from the object DB 140, arranges the selected object in the three-dimensional space, resizes the object, and performs environment settings for an FDS to author content for an FDS (S810).

The authoring system generates the FDS input file, which is an input file for the FDS simulator, from the content for an FDS (S820). The authoring system converts the content for an FDS into the FDS input file using parsing technology, and outputs the FDS input file to the FDS simulator.

The FDS simulator performs the FDS based on the FDS input file.

The authoring system acquires FDS result from the FDS simulator (S830) and visualizes the FDS result (S840).

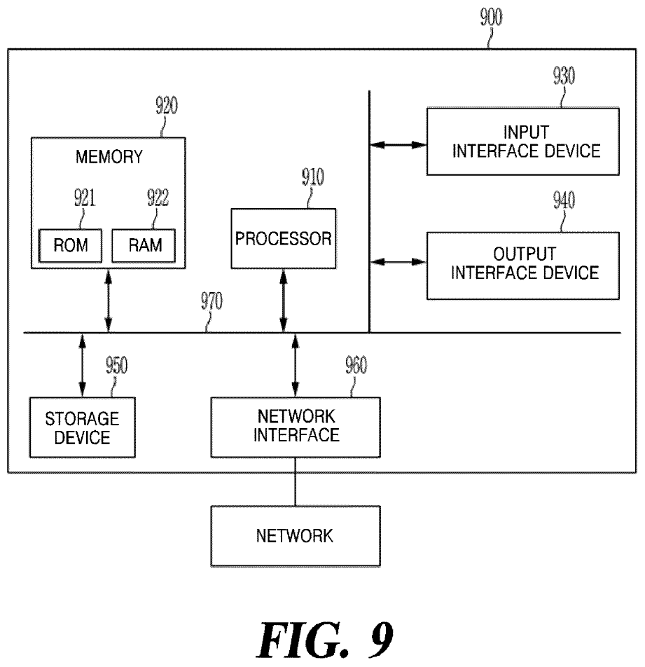

FIG. 9 is a diagram illustrating an authoring system for an FDS according to another embodiment.

Referring to FIG. 9, an authoring system 900 for an FDS may indicate the computing device in which the above-described authoring method for an FDS has been implemented.

The authoring system 900 for an FDS may include at least one of a processor 910, a memory 920, an input interface device 930, an output interface device 940, a storage device 950, and a network interface device 960. Each of the components may be connected by a common bus 970 to perform communication with each other. Further, the respective components may be connected through an individual interface or individual bus around the processor 910 instead of the common bus 970.

The processor 910 may be implemented as various types such as an application processor (AP), a central processing unit (CPU) and a graphic processing unit (GPU), and may be any semiconductor device that executes commands stored in the memory 920 or the storage device 950. The processor 910 may execute program commands stored in at least one of the memory 920 and the storage device 950. The processor may store in the memory 920 program commands to implement at least some functions of the authoring unit 110, the FDS input file generation unit 120, and the visualization unit 130 shown in FIG. 1 to perform control so that the operation described based on FIGS. 1 to 8 is performed.

The memory 920 and the storage device 950 may include various types of volatile or non-volatile storage media. For example, the memory 920 may include a read-only memory (ROM) 921 and a random access memory (RAM) 922. The memory 920 may be located inside or outside the processor 910, and the memory 920 may be connected to the processor 910 through various known means.

The memory 920 or the storage device 950 may store the object DB 140 and the fire attribute DB 150 illustrated in FIG. 1.

The input interface device 930 is configured to provide data to the processor 910. For example, the input interface device 930 may provide the FDS result of the simulator for an FDS to the processor 910.

The output interface device 940 is configured to output data from the processor 910. For example, the input interface device 930 may output the FDS input file to a simulator for an FDS.

The network interface device 960 may transmit or receive signals to or from other devices through a wired network or a wireless network.

The input interface device 930, the output interface device 940, and the network interface device 960 may be collectively referred to as a user interface.

At least part of the authoring method for an FDS according to the embodiment of the present disclosure may be implemented by a program or software executed on the computing device, and the program or software may be stored in a computer-readable medium.

Further, at least part of the authoring method for an FDS according to the embodiment of the present disclosure may be implemented as hardware that can be electrically connected to the computing device.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method, performed by an authoring system, of authoring content for a high-precision fire-dynamics-simulation (FDS), the method comprising:
selecting a target object from an object DB storing a three-dimensional model of each object made to correspond to surface information indicating at least one material constituting a surface of the three-dimensional model and material information indicating fire attribute information of each material;
arranging the selected target object in a three-dimensional space to author content for the FDS;
converting the content for the FDS into an FDS input file used as an input for a simulator for the FDS; and
outputting the FDS input file to the simulator.

2. The method of claim 1, further comprising:
receiving surface information for a surface of a three-dimensional model of a new object and fire attribute information for the surface information from a user by referring to a fire attribute DB, which comprises a plurality of pieces of surface information including a plurality of materials and has the material information indicating the fire attribute information of each corresponding material set in the plurality of pieces of surface information; and
storing in the object DB the surface information and the fire attribute information made to correspond to the three-dimensional model of the new object.

3. The method of claim 2, further comprising:
modifying the fire attribute information stored in the fire attribute DB or registering new fire attribute information.

4. The method of claim 3, wherein, when the fire attribute information stored in the fire attribute DB is changed, the changed fire attribute information is reflected in the object DB.

5. The method of claim 1, wherein the authoring comprises
arranging the selected target object in the three-dimensional space; and
modifying the fire attribute information of the at least one material constituting the surface of the three-dimensional model.

6. The method of claim 1, wherein the fire attribute information comprises at least one of specific heat, conductivity, density, heat of combustion, or heat of reaction of the material.

7. The method of claim 1, wherein the authoring comprises performing environment settings for the FDS in the three-dimensional space.

8. The method of claim 1, further comprising:
acquiring an FDS result from the simulator; and
visualizing the FDS result.

9. An authoring system for authoring content for a high-precision fire-dynamics-simulation (FDS), the authoring system comprising:
an object DB configured to store surface information indicating at least one material constituting a surface of a three-dimensional model of each object and material information indicating fire attribute information of the material together with the three-dimensional model made to correspond to each other;
an authoring unit configured to select a target object from the object DB, and arrange the selected target object in a three-dimensional space to author content for an FDS; and
an FDS input file generation unit configured to convert the content for the FDS into an FDS input file used as an input for a simulator for the FDS, and output the FDS input file to the simulator.

10. The authoring system of claim 9, further comprising:
a fire attribute DB including a plurality of pieces of surface information comprising a plurality of materials and having the material information indicating the fire attribute information of each corresponding material set in the plurality of pieces of surface information,
wherein the authoring unit includes an object DB management unit configured to receive surface information for a surface of a three-dimensional model of a new object and fire attribute information for the surface information from a user by referring to the fire attribute DB, and store in the object DB the surface information and the fire attribute information made to correspond to the three-dimensional model of the new object.

11. The authoring system of claim 10,
wherein the authoring unit further comprises a fire attribute management unit configured to manage the fire attribute DB, and
the management comprises modification of the fire attribute information of the fire attribute DB and registration of new fire attribute information.

12. The authoring system of claim 10, wherein the authoring unit further comprises an environment setting unit configured to set an environment of the three-dimensional space for performing the FDS.

13. The authoring system of claim 10, wherein the arrangement unit arranges the three-dimensional model of the selected target object in the three-dimensional space and modifies a fire attribute of the material constituting the surface of the three-dimensional model by referring to the fire attribute DB.

14. The authoring system of claim 9, wherein the fire attribute information comprises at least one of specific heat, conductivity, density, heat of combustion, or heat of reaction of the material.

15. The authoring system of claim 9, further comprising:
a visualization unit configured to acquire an FDS result from the simulator and visualize the FDS result.
